(19) United States
(12) Patent Application Publication
(10) Pub. No.: US 2013/0286385 A1
(43) Pub. Date: Oct. 31, 2013

(54) INSPECTION APPARATUS

(71) Applicants: Yusuke Miyazaki, Hitachinaka (JP); Takahiro Jingu, Takasaki (JP); Katsuya Suzuki, Hitachinaka (JP)

(72) Inventors: Yusuke Miyazaki, Hitachinaka (JP); Takahiro Jingu, Takasaki (JP); Katsuya Suzuki, Hitachinaka (JP)

(73) Assignee: HITACHI HIGH-TECHNOLOGIES CORPORATION, Tokyo (JP)

(21) Appl. No.: 13/994,755

(22) PCT Filed: Dec. 7, 2011
(86) PCT No.: PCT/JP2011/006836

§ 371 Date: Jun. 16, 2013

(30) Foreign Application Priority Data
Dec. 24, 2010 (JP) 2010-286917

(51) Int. Cl. G01N 21/95

(52) U.S. Cl. CPC G01N 21/9501
USPC 356/237.2

(57) ABSTRACT

To increase the speed of inspection, an inspection apparatus may conduct an inspection by irradiating a wafer surface with a thin light beam and acquiring an image of an irradiated region with a photodetector. However, it is not easy to have the photodetector properly form the image of the irradiated region. This problem is not solved by prior art technologies.

The present invention includes an image formation optical system having an optical fiber bundle, and additionally includes a mechanism for rotating the light condensing side of the optical fiber bundle. The present invention enables the photodetector to properly form the image of light scattered from the irradiated region.

### TECHNICAL FIELD

The present invention relates to an apparatus and method for inspecting a substrate for defects such as scratches and foreign matter.

### BACKGROUND ART

In various semiconductor device manufacturing processes, a circuit is formed by transferring a pattern onto the surface of a wafer and etching the wafer surface. In such semiconductor device manufacturing processes for circuit formation, defects on the wafer surface constitute a major cause of a decrease in the yield rate.

As such being the case, the defects on the wafer surface are managed in each manufacturing process to take measures to reduce the defects. A wafer surface inspection apparatus detects foreign matter attached to the wafer surface and defects existing on the wafer surface with high sensitivity and at high throughput.

The wafer surface inspection apparatus irradiates the wafer surface with laser light or other electromagnetic waves and uses a detector to receive light scattered from a defect or foreign matter by the irradiated light for the purpose of detecting the size of the foreign matter and acquiring positional coordinate data about the foreign matter. While an inspection table on which a wafer is mounted rotates at a high speed, a stage on which the inspection table is disposed moves in a uniaxial direction on the same plane as an inspection plane to scan the wafer by inspection laser light in order to increase the throughput of inspection. This surface inspection apparatus is described in Patent Document 1.

Other relevant technologies are described, for instance, in Patent Documents 2 and 3.

### PRIOR ART LITERATURE

### Patent Documents

Patent Document 1: JP-2005-156537-A
Patent Document 2: JP-2001-311608-A
Patent Document 3: JP-2009-88026-A

### SUMMARY OF THE INVENTION

### Problem to be Solved by the Invention

To increase the speed of inspection, an inspection apparatus may conduct an inspection by irradiating the wafer surface with a thin light beam and acquiring an image of an irradiated region with a photodetector. However, it is not easy to have the photodetector properly form the image of the irradiated region. This problem is not solved by prior art technologies.

### Means for Solving the Problem

The present invention includes an image formation optical system having an optical fiber bundle, and additionally includes a mechanism for rotating the light condensing side of the optical fiber bundle.

### Effects of the Invention

The present invention enables a photodetector to properly form the image of light scattered from the irradiated region.

### BRIEF DESCRIPTION OF THE DRAWINGS

FIG. 1 is a schematic diagram illustrating the configuration of a surface inspection apparatus according to an embodiment of the present invention.

FIG. 2 is a diagram illustrating in detail an inspection section 200.

FIG. 3 is a top view illustrating the relationship between a wafer 1 and first to fourth image formation optical systems 291 to 294.

FIG. 4 is a diagram illustrating how scattered light is condensed to form an image.

FIG. 5 is a diagram illustrating a first end 283 and a second end 284.

FIG. 6 shows diagrams illustrating the angular correction of an optical fiber bundle.

### MODE FOR CARRYING OUT THE INVENTION

### Embodiment

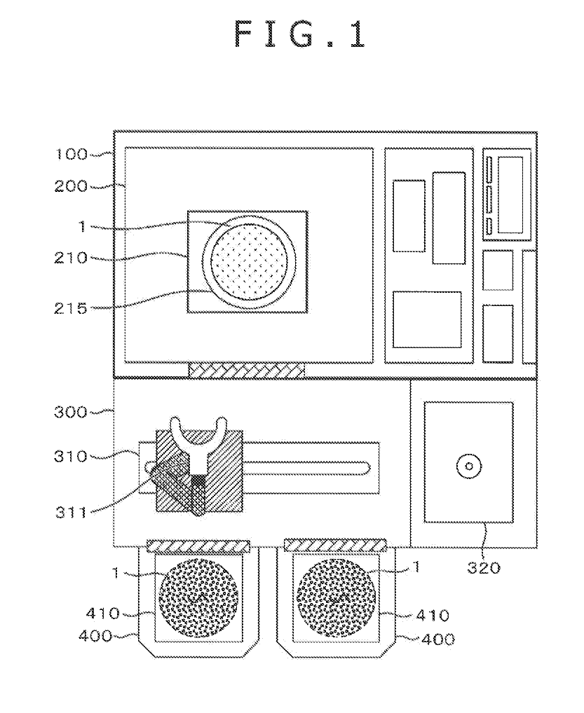

FIG. 1 is a schematic diagram illustrating the configuration of a surface inspection apparatus according to an embodiment of the present invention.

A wafer 1, which is to be inspected, is placed in a wafer pod 410, which is a container.

The wafer pod 410 is disposed at a load port 400 of the inspection apparatus.

A wafer transport robot 310 is disposed in a wafer transport unit 300.

The wafer transport robot 310 includes a wafer handling arm 311 for transporting the wafer 1.

The wafer handling arm 311 picks up the wafer 1 placed in the wafer pod 410 and moves to a pre-alignment section 320.

The pre-alignment section 320 performs pre-alignment by calculating the center position of the wafer 1 and a notch position in order to enable a later-described inspection section 200 to properly achieve positioning.

The wafer handling arm 311 moves the pre-aligned wafer 1 to a wafer retention mechanism 215 on an inspection stage 210 in the inspection section 200.

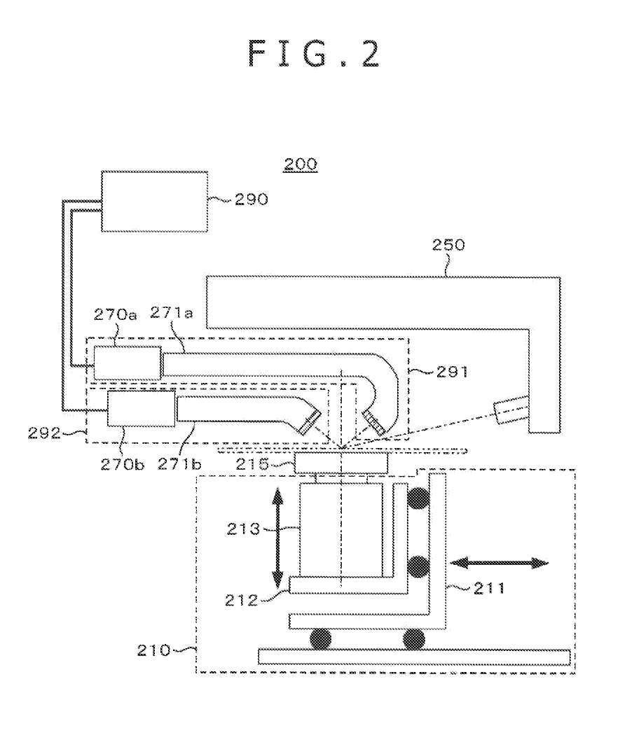

FIG. 2 is a diagram illustrating the details of the inspection section 200.

The inspection stage 210 described with reference to FIG. 1 rotates the wafer 1 at a high speed while moving in a straight line. The inspection stage 210 includes an X stage 211, a Z stage, and a θ stage 213. The X stage 211 moves horizontally in a straight line. The Z stage is mounted on the X stage to adjust the height of the wafer 1. The θ stage 213 is mounted on the Z stage 211 to rapidly rotate the wafer 1. The θ stage 213 includes a spindle motor or other rapidly rotating part. The wafer retention mechanism 215 is disposed on the θ stage 213

A light irradiation section 250 is disposed substantially above the inspection stage 210 to irradiate the wafer 1 with light. The light irradiation section 250 obliquely irradiates the wafer with a linear light beam.

Light scattered from the wafer 1 is condensed to form an image for detection purposes by a first image formation optical system 291, a second image formation optical system 292, a third image formation optical system 293, and a fourth image formation optical system 294.

The first image formation optical system 291 includes a first optical fiber array 271a and a first photodetector 270a disposed on the image forming side of the first optical fiber array 271a.

The second image formation optical system 292 includes a second optical fiber array 271b and a first photodetector 270b disposed on the image forming side of the first optical fiber array 271b.

Each photodetector 270a, 270b is a photoelectric converter such as a CCD having a plurality of pixels, a CMOS sensor, a rapid-response avalanche photodiode (APD) array, or a multi-pixel photon counter.

The third image formation optical system 293 and the fourth image formation optical system 294 have the same configuration as described above.

Signals detected by the photodetectors 270a, 270b are compared to a threshold value in a processing section 290. Any signal greater than the threshold value is determined to be a defect. Detection results produced by the photodetectors 270a, 270b are also used to classify defects.

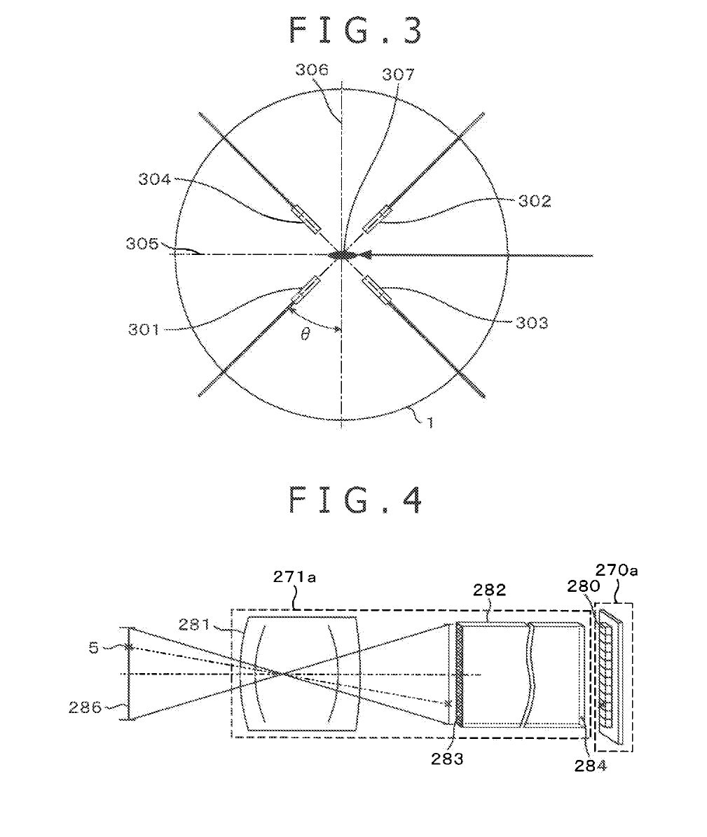

FIG. 3 is a top view illustrating the relationship between the wafer 1 and the first to fourth image formation optical systems 291 to 294.

The first to fourth image formation optical systems 291 to 294 each include an optical fiber array. Each optical fiber array includes an end for condensing scattered light (this end hereinafter referred to as the light condensing side).

The first image formation optical system 291 includes a first light condensing side 301. The second image formation optical system 292 includes a second light condensing side 302. The third image formation optical system 293 includes a third light condensing side 303. The fourth image formation optical system 294 includes a fourth light condensing side 304.

The first to fourth light condensing sides 301 to 304 are disposed to surround an irradiation spot 307 formed by light irradiated on the wafer 1.

For example, the first light condensing side 301 is disposed at a certain azimuth angle α with respect to the wafer 1. The third light condensing side 303 and the first light condensing side 301 are disposed line-symmetrically about an axis 306 orthogonal to a projection line 305 that is formed on the wafer 1 by irradiated light. The second light condensing side 302 and the third light condensing side 303 are disposed line-symmetrically about the projection line 305. The fourth light condensing side 304 and the first light condensing side 301 are disposed line-symmetrically about the projection line 305. The first to fourth light condensing sides 301 to 304 are at the same elevation angle with respect to the wafer. The above-described layout ensures that defects can be detected with high efficiency. Further, as the optical fiber arrays propagate condensed light, the photodetectors can be disposed at an arbitrary position.

FIG. 4 is a diagram illustrating how scattered light is condensed to form an image. Although the description given below relates to the first image formation optical system 291, the same holds true for the second to fourth image formation optical systems.

As mentioned earlier, the first image formation optical system 291 includes the first optical fiber array 271a and the first photodetector 270a.

The first photodetector 270a includes an optical sensor array 280 that provides photoelectric conversion.

The first optical fiber array 271a includes a bundle 282 of optical fibers. The first optical fiber array 271a also includes a lens 281 that is disposed before a first end 283 of the bundle 282 to condense onto the first end 283 the light scattered from an irradiated region 286. The lens 281 may be a microlens array that has a lens for each optical fiber in the bundle 282.

It can be said that the first light condensing side includes the lens 281 and the first end 283.

The optical sensor array 280 has pixels D1 to Dn. The pixels D1 to Dn are linearly arranged.

Scattered light generated from the irradiated region 286 is condensed by the lens 281. The condensed light forms an image at the first end 283. The image of the irradiated region, which is formed in the above manner, propagates toward a second end 284 and is photoelectrically converted by the optical sensor array 280. In the present embodiment, light scattered from a defect 5 is detected by the pixel D3.

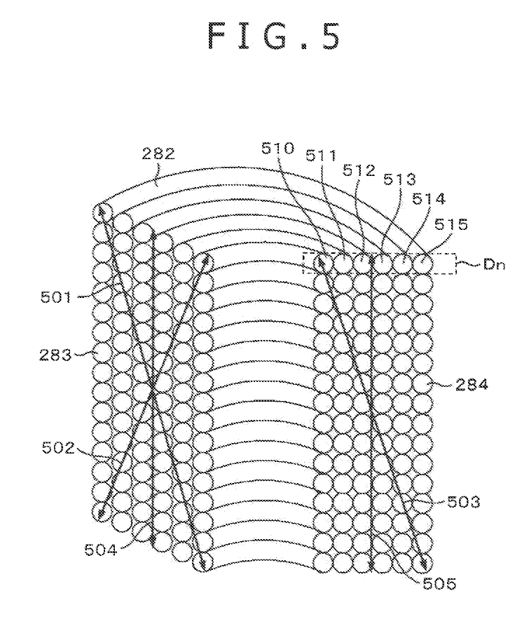

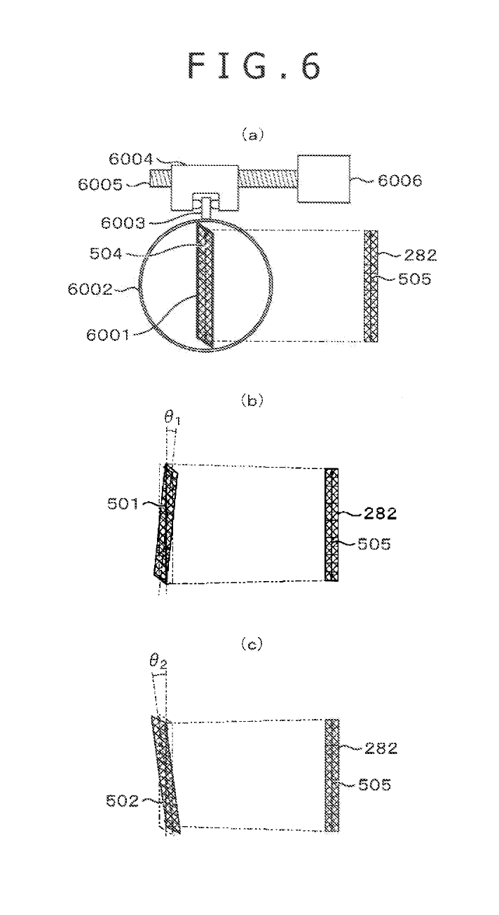

FIG. 5 is a diagram illustrating the first end 283 and the second end 284.

At the first end 283, the optical fiber bundle is shaped like a parallelogram whose diagonal lines are a long axis 501 and a short axis 502 shorter than the long axis 501. A later-described correction can be made by using these two axes. The shape of the first end 283 is not limited to the parallelogram described in conjunction with the present embodiment. The first end 283 may be in any shape as far as it has two axes different in length.

Meanwhile, the second end 284 is shaped like a rectangle having a diagonal line 53. The relationship between the long axis 501, the short axis 502, and the diagonal line 503 can be expressed as follows:

Short axis 502<diagonal line 503<long axis 501

The relationship between a long side 504 of the first end 283 and a long side 505 of the second end 284 can be expressed as follows:

Long side 504=long side 505

The aforementioned pixel Dn is shaped like a rectangle and used to detect light from the optical fibers 510 to 515.

The above-described configuration makes it possible to properly detect the light scattered from the irradiated region at all times when the later-described correction is made.

The angular correction of the optical fiber bundle will now be described with reference to FIG. 6.

The first end 283 includes a holder 6001 and a holder 6002. The holder 6001 is used to retain the shape of the first end 283. The holder 6002 is substantially shaped like a circle and used to rotate the holder 6001. A cylindrical pin 6003 is disposed on the holder 6002. A transfer mechanism 6004 having a dent is disposed near the pin 6003. The pin 6003 is surrounded by the dent in the transfer mechanism 6004. The transfer mechanism 6004 is connected to a ball screw 6005 that linearly moves the transfer mechanism 6004. The ball screw 6005 is connected to a rotating body 6006 (e.g., a motor) for rotating the ball screw 6005. In other words, the first end rotates when the rotating body 6006 rotates. If, for instance, the rotating body 6006 is a stepper motor, a pulse signal corresponding to the rotation angle of the first end 283 should be sent to the stepper motor.

FIG. 6(a) shows a case where the light scattered from the irradiated region is formed into an image at the first end 283 by the lens 281 so that the formed image has substantially the same length as the long side 504 of the first end. In this case, no correction is needed.

FIG. 6(b) shows a case where the light scattered from the irradiated region is formed into an image at the first end 283 by the lens 281 so that the formed image is longer than the long side 54 of the first end. In this case, the first end 283 is rotated through an angle of θ1 along the long axis 501.

FIG. 6(c) shows a case where the light scattered from the irradiated region is formed into an image at the first end 283 by the lens 281 so that the formed image is shorter than the long side 54 of the first end. In this case, the first end 283 is rotated through an angle of θ2 along the short axis 502.

The present embodiment provides control over the above-described correction. When the above-described correction is made, the light scattered from the irradiated region can be properly formed into an image in the photodetectors at all times.

### DESCRIPTION OF REFERENCE SYMBOLS

1 . . . Wafer
200 . . . Inspection section
210 . . . Inspection stage
270a . . . First photodetector
270b . . . Second photodetector
271a . . . First optical fiber array
271b . . . Second optical fiber array
280 . . . Optical sensor array
281 . . . Lens
282 . . . Bundle
283 . . . First end
284 . . . Second end
291 . . . First image formation optical system
292 . . . Second image formation optical system
301 . . . First light condensing side
302 . . . Second light condensing side
305 . . . Projection line
400 . . . Load port
410 . . . Wafer pod
501 . . . Long axis
502 . . . Short axis

1. An inspection apparatus for inspecting a substrate, comprising:
an irradiation optical system that irradiates the substrate with light;
a detection optical system that condenses light from the substrate with a bundle of optical fibers to form an image;
a rotating section that rotates the light condensing side of the bundle of the optical fibers;
a photodetector that is disposed on the image forming side of the optical fibers to detect the formed image; and
a processing section that detects a defect on the substrate by using the result of detection by the photodetector.

2. The inspection apparatus according to claim 1, wherein the cross section of the light condensing side is a parallelogram.

3. The inspection apparatus according to claim 1, wherein the cross section of the image forming side is a rectangle.

4. The inspection apparatus according to claim 1, further comprising
a first holder for retaining the shape of the light condensing side.

5. The inspection apparatus according to claim 1, further comprising
a second holder for rotating the first holder.

6. The inspection apparatus according to claim 1, wherein the cross section of the light condensing side is shaped to have a long axis and a short axis, the short axis being shorter than the long axis;
wherein the cross section of the image forming side is a quadrangle; and
wherein the diagonal lines of the quadrangle are longer than the short axis and shorter than the long axis.
